(19) United States
(12) Patent Application Publication
(10) Pub. No.: US 2013/0141401 A1
(43) Pub. Date: Jun. 6, 2013

(54) DRIVING CIRCUIT OF LCD AND DRIVING METHOD THEREOF

(71) Applicant: Chihtsung Kang, Shenzhen (CN)

(72) Inventor: Chihtsung Kang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/380,885

(22) PCT Filed: Dec. 5, 2011
(86) PCT No.: PCT/CN2011/083443

§ 371 Date: Dec. 26, 2011

(30) Foreign Application Priority Data
Dec. 2, 2011 (CN) 201110396262.0

(51) Int. Cl. G09G 5/00; G09G 3/36

(52) U.S. Cl. 345/204; 345/87

(57) ABSTRACT

The present invention relates a driving circuit of an LCD which includes a panel and a plurality of data lines. The driving circuit of the LCD includes: a receiving module for receiving electric signals corresponding to the data lines at each position of the panel; a compensation module for compensating the electric signals according to transmission paths corresponding to the electric signals and a predetermined mapping table; and an output module for outputting the compensated electric signals to the display panel for displaying. The present invention further relates a driving method of the LCD. The driving circuit of the LCD and the driving method thereof can perform modulation compensation for the electric signals that are outputted form a chip to the data lines at each position of the panel.

### FIELD OF THE INVENTION

Generally, a reasonable fan-out region has to be designed in surrounding circuits of an output chip. Voltage differences between sides and middle of the chip caused by the differences between data signals of various transmission paths is decreased mainly through designed area differences of resistances on the fan-out region, thereby reducing the effect with respect to charging ability for pixels and making luminance of the display panel uniform.

FIG. 1 is a schematic drawing illustrating a Chip On Film (COF) panel. Electric signals of the output chip 110 are required to transmit to the data lines at corresponding positions of the panel. Due to the differences between the data signals of the various transmission paths (or impedance), the transmission path R2 of the second data line 140 on the fan-out region 120 is shorter than the transmission path R1 of the first data line 130 on the fan-out region 120 and the transmission path R3 of the third data line 150 on the fan-out region 120. The shorter transmission path R2 means that the resistance of the second data line 140 is smaller than the resistances of the first data line 130 and the third data line 150. If the fan-out region 120 has no corresponding compensations for the non-matching of the resistances of the first data line 130, the second data line 140 and the third data line 150, it is very apt to cause that the non-uniformity of the luminance on both sides and middle regions of the panel is seen.

Conventional improved method is to increase a depth d of the fan-out region 120 and/or to change the path patterns of the transmission path R1, the transmission path R2, and the transmission path R3 on the fan-out region 120 to specially modify, thereby reducing the resistance differences between the transmission path R2 and both sides of the transmission path R1 and the transmission path R3 for reducing the non-uniformity of the luminance on the display panel. However, a drawback of said way is that the impedance matching for modifying the fan-out region 120 is restricted to available sheet resistances of processes and available line widths of photo-masks. If the path differences of the transmission path R1, the transmission path R2 and the transmission path R3 are too big, the resistance differences can not be completely modified under the restriction of the available sheet resistances and line widths. Under this condition, the depth d of the fan-out region 120 has to be elongated to obtain a larger space for the impedance matching, which would cause a viewable range or a peripheral wire distribution being compressed.

Therefore, there is a significant need to provide a driving circuit of an LCD and a driving method thereof for solving the problem existing in the prior art.

### SUMMARY OF THE INVENTION

An objective of the present invention is to provide a driving circuit of an LCD and a driving method thereof with capability to perform modulation compensation for electric signals that are outputted form a chip to data lines at each position of a panel, thereby solving the drawback that the conventional driving circuit of the LCD and the driving method thereof cause the non-uniformity of the luminance on the display panel or the compressed viewable range or the compressed peripheral wire distribution.

To achieve the foregoing objective, the technical solution of this invention is implemented as follows.

A driving circuit of a liquid crystal display (LCD), the LCD comprising a panel and a plurality of data lines, the driving circuit of the LCD comprises a receiving module for receiving electric signals corresponding to the data lines at each position of the panel; a compensation module for compensating the electric signals according to transmission paths corresponding to the electric signals and a predetermined mapping table; and an output module for outputting the compensated electric signals to the display panel for displaying. The predetermined mapping table in the compensation module is mapping relations between the transmission paths and signal distortion compensations as well as over-driving signal compensations corresponding to the electric signals. The compensation module comprises a multiplexer to perform modulation compensation for multiplexed signals, and said multiplexer is coupled to the receiving module and the output module.

In the driving circuit for the LCD of the present invention, signal distortion compensation codes and over-driving signal compensation codes corresponding to the electric signals of the various transmission paths are disposed in the predetermined mapping table.

In the driving circuit for the LCD of the present invention, common signal distortion compensation codes, common over-driving signal compensation codes, signal distortion compensation weights corresponding to the electric signals of the various transmission paths, and over-driving signal compensation weights corresponding to the electric signals of the various transmission paths are disposed in the predetermined mapping table.

In the driving circuit for the LCD of the present invention, signal distortion compensation codes corresponding to the electric signals of the various transmission paths are produces of the common signal distortion compensation codes times the corresponding signal distortion compensation weights, and over-driving signal compensation codes corresponding to the electric signals of the various transmission paths are produces of the common over-driving signal compensation codes times the corresponding over-driving signal compensation weights.

A driving circuit of a liquid crystal display (LCD), the LCD comprising a panel and a plurality of data lines, the driving circuit of the LCD comprises: a receiving module for receiving electric signals corresponding to the data lines at each position of the panel; a compensation module for compensating the electric signals according to transmission paths corresponding to the electric signals and a predetermined mapping table; and an output module for outputting the compensated electric signals to the display panel for displaying.

In the driving circuit for the LCD of the present invention, the predetermined mapping table in the compensation module is mapping relations between the transmission paths and signal distortion compensations as well as over-driving signal compensations corresponding to the electric signals.

In the driving circuit for the LCD of the present invention, signal distortion compensation codes and over-driving signal compensation codes corresponding to the electric signals of the various transmission paths are disposed in the predetermined mapping table.

In the driving circuit for the LCD of the present invention, common signal distortion compensation codes, common over-driving signal compensation codes, signal distortion compensation weights corresponding to the electric signals of the various transmission paths, and over-driving signal compensation weights corresponding to the electric signals of the various transmission paths are disposed in the predetermined mapping table.

In the driving circuit for the LCD of the present invention, signal distortion compensation codes corresponding to the electric signals of the various transmission paths are produces of the common signal distortion compensation codes times the corresponding signal distortion compensation weights, and over-driving signal compensation codes corresponding to the electric signals of the various transmission paths are produces of the common over-driving signal compensation codes times the corresponding over-driving signal compensation weights.

In the driving circuit for the LCD of the present invention, the signal distortion compensations are signal distortion compensations for the transmission paths of R electric signals, B electric signals, or G electric signals.

In the driving circuit for the LCD of the present invention, the over-driving signal compensations are over-driving signal compensations for accelerating response rate of liquid crystals of R electric signals, B electric signals, or G electric signals.

In the driving circuit for the LCD of the present invention, the compensation module comprises a multiplexer to perform modulation compensation for multiplexed signals, and said multiplexer is coupled to the receiving module and the output module.

The present invention further relates a driving method of an LCD, the LCD comprising a panel and a plurality of data lines, the method comprises the step of: A, receiving electric signals corresponding to the data lines at each position of the panel; B, compensating the electric signals according to transmission paths corresponding to the electric signals and a predetermined mapping table; and C, outputting the compensated electric signals to the display panel for displaying.

In the driving method of the LCD of the present invention, the predetermined mapping table in step B is mapping relations between the transmission paths and signal distortion compensations as well as over-driving signal compensations corresponding to the electric signals.

In the driving method of the LCD of the present invention, signal distortion compensation codes and over-driving signal compensation codes corresponding to the electric signals of the various transmission paths are disposed in the predetermined mapping table.

In the driving method of the LCD of the present invention, common signal distortion compensation codes, common over-driving signal compensation codes, signal distortion compensation weights corresponding to the electric signals of the various transmission paths, and over-driving signal compensation weights corresponding to the electric signals of the various transmission paths are disposed in the predetermined mapping table.

In the driving method of the LCD of the present invention, signal distortion compensation codes corresponding to the electric signals of the various transmission paths are produces of the common signal distortion compensation codes times the corresponding signal distortion compensation weights, and over-driving signal compensation codes corresponding to the electric signals of the various transmission paths are produces of the common over-driving signal compensation codes times the corresponding over-driving signal compensation weights.

The advantageous effects of the driving circuit of the LCD and the driving method of the present invention lie in: the electric signals that are outputted form the chip to the data lines at each position of the panel can be performed modulation compensation, thereby solving the drawback that the conventional driving circuit of the LCD and the driving method thereof cause the non-uniformity of the luminance on the display panel or the compressed viewable range or the compressed peripheral wire distribution.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a schematic drawing illustrating a COF panel in prior art;

FIG. 2 is a schematic block diagram illustrating a driving circuit of an LCD according to one preferred embodiment of the present invention;

FIG. 3 is a flow chart illustrating a driving method of the LCD according to a preferred embodiment of the present invention;

FIG. 4 is a schematic drawing illustrating a compensation module of the driving circuit of the LCD according to a first preferred embodiment of the present invention; and

FIG. 5 is a schematic drawing illustrating a compensation module of the driving circuit of the LCD according to a second preferred embodiment of the present invention.

### DETAILED DESCRIPTION OF THE PREFERRED EMBODIMENTS

Descriptions of the following embodiments refer to attached drawings which are utilized to exemplify specific embodiments. In different drawings, the same reference numerals refer to like parts throughout the drawings.

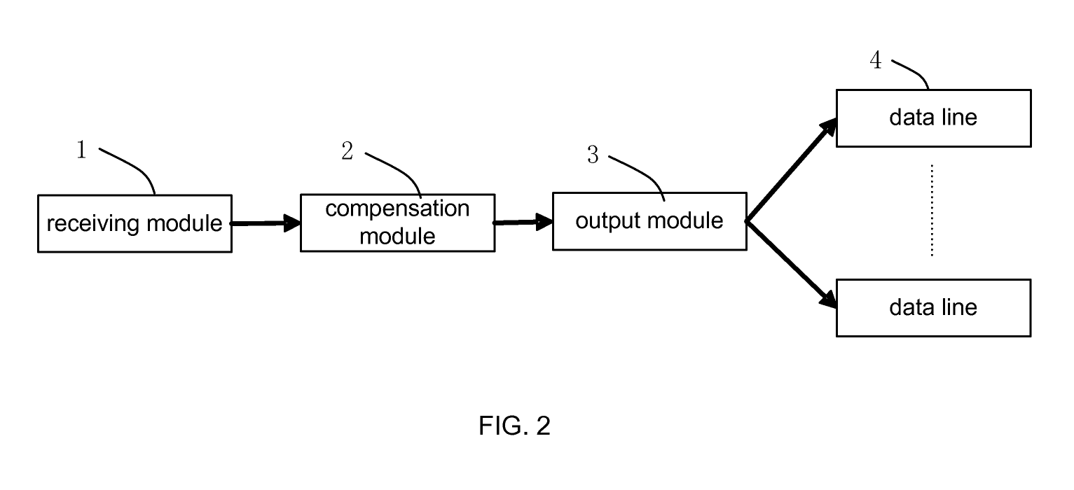

In FIG. 2 that is a schematic block diagram illustrating a driving circuit of an LCD according to one preferred embodiment of the present invention, the LCD includes a panel and a plurality of data lines 4. The driving circuit of the LCD includes a receiving module 1, a compensation module 2 and an output module 3. The receiving module is utilized to receive electric signals corresponding to the data lines 4 at each position of the panel. The compensation module is utilized to compensate the electric signals according to transmission paths corresponding to the electric signals and a predetermined mapping table. The output module is utilized to output the compensated electric signals to the display panel for displaying.

As shown in FIG. 2, before entering the output module 3, the electric signals of the driving circuit on the LCD of the present invention enter the compensation module 2 for performing compensation for the electric signals. Accordingly, the voltages of the electric signals outputted to the data line 4 of various positions on the panel can be modified, and then the depth d of the fan-out region can be reduced for achieving an objective of a narrow bezel. Meanwhile, it can perform an amendment for the non-uniformity of the luminance on the display panel through the compensation of the signals.

In accordance with the driving circuit of the LCD the preferred embodiment of the present invention, the predetermined mapping table in the compensation module 2 is mapping relations between the transmission paths and signal distortion compensations as well as over-driving signal compensations corresponding to the electric signals. The signal distortion compensations herein are signal distortion compensations for the transmission paths of R electric signals, B electric signals, or G electric signals. The over-driving signal compensations herein are over-driving signal compensations for accelerating response rate of liquid crystals of the R electric signals, the B electric signals, or the G electric signals.

The compensation capability for the electric signal is added to the compensation module 2 in the driving circuit of the LCD of the present invention. The compensation module 2 employs line selection signals to perform multitasking select aimed at the signal distortion compensations for the transmission paths and the over-driving signal compensating outputs for accelerating the response rate of the liquid crystals corresponding to the R, G, and B electric signals. The predetermined mapping table is utilize to perform different compensations for the signal distortions for the transmission paths and the over-driving signal outputs for accelerating the response rate of the liquid crystals corresponding to the R, G, and B electric signals of the transmission paths, thereby achieving the objective of increasing the uniformity on the display panel.

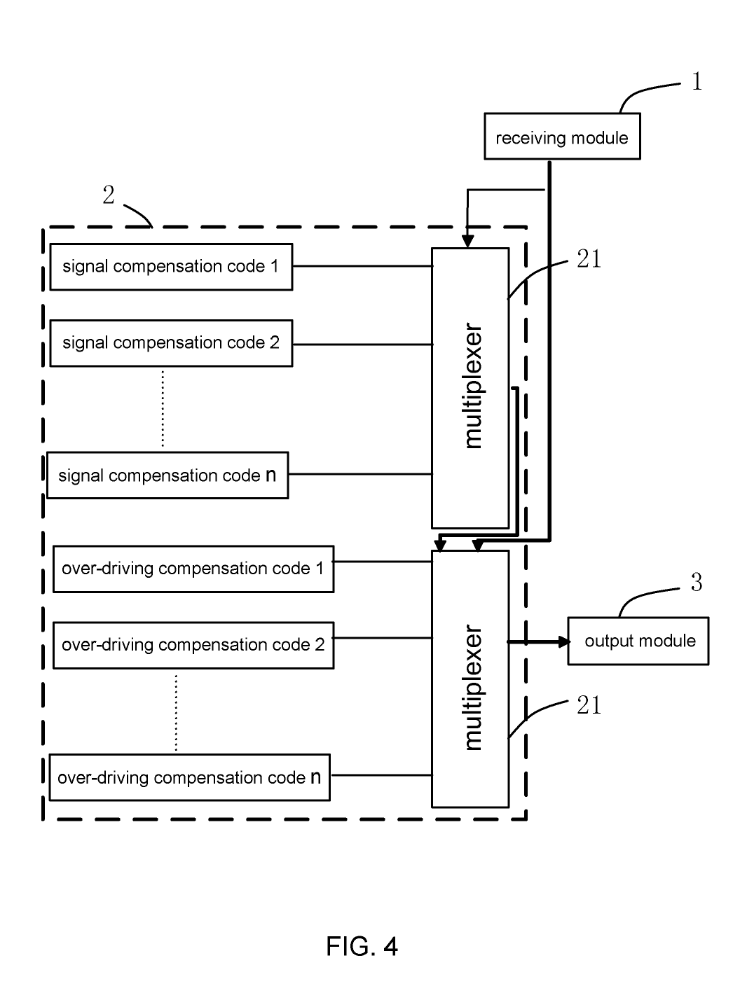

FIG. 4 depicts a schematic drawing illustrating a compensation module of the driving circuit of the LCD according to a first preferred embodiment of the present invention. In the embodiment, signal distortion compensation codes for the transmission paths and over-driving signal compensation codes for accelerating the response rate of the liquid crystals corresponding to the R, G, and B electric signals of the various transmission paths are disposed in the predetermined mapping table.

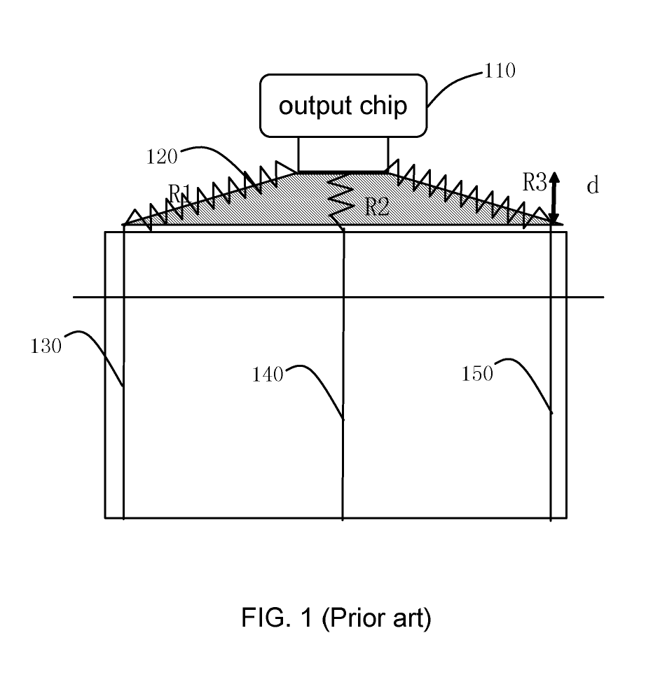

When the compensation module 2 receives the electric signal of the receiving module 1, the corresponding transmission paths can be determined according to the line selection signals. Accordingly, the signal distortion compensation codes (as the signal compensation code 1, the signal compensation code 2, and so on shown in FIG. 1) for the transmission paths and the over-driving signal compensation codes (the over-driving compensation code 1, the over-driving compensation code 2, and so on) for accelerating the response rate of the liquid crystals corresponding to the R, G, and B electric signals can be determined. Then the multiplexer 21 is employed to modulate and compensate according to the signal distortion compensation codes for the transmission paths and the over-driving signal compensation codes for accelerating the response rate of the liquid crystals in the mapping table. Finally, the output module 3 is utilized to output the compensated electric signals to the display panel for displaying. In accordance with actual differences of the electric signal, the driving circuit can directly preset the desired signal distortion compensation codes for the transmission paths and the over-driving signal compensation codes for accelerating the response rate of the liquid crystals so as to directly compensate the electric signal from the various transmission paths. It is not easy to generate compensation mistakes.

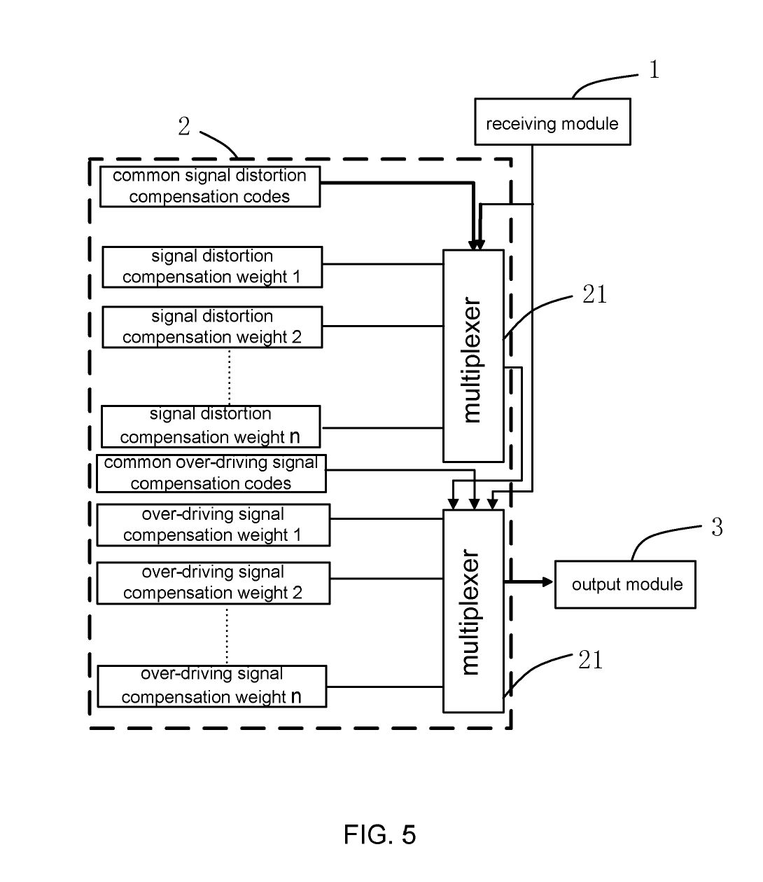

FIG. 5 depicts a schematic drawing illustrating a compensation module of the driving circuit of the LCD according to a second preferred embodiment of the present invention. In the embodiment, common signal distortion compensation codes (as the common signal distortion compensation codes shown in the drawing) of the transmission path corresponding to the R, G, and B electric signals, and common over-driving signal compensation codes (as the common over-driving signal compensation codes shown in the drawing) for accelerating the response rate of the liquid crystals corresponding to the R, G, and B electric signals, and signal distortion compensation weights (the signal distortion compensation weight 1, the signal distortion compensation weight 2, and so on) for the transmission paths corresponding to the various transmission paths, and over-driving signal compensation weights (as the over-driving signal compensation weight 1, the over-driving signal compensation weight 2, and so on shown in the drawing) for accelerating the response rate of the liquid crystals corresponding to the various transmission paths are disposed in the predetermined mapping table. The signal distortion compensation codes corresponding to the R, G, and B electric signals of the various transmission paths are the produces of the common signal distortion compensation codes for the transmission paths corresponding to the R, G, and B electric signals times the corresponding signal distortion compensation weights for the transmission paths. The over-driving signal compensation codes for accelerating the response rate of the liquid crystals corresponding to the R, G, and B electric signals of the various transmission paths are the produces of the common over-driving signal compensation codes for accelerating the response rate of the liquid crystals corresponding the R, G, and B electric signals times the corresponding over-driving signal compensation weight for accelerating the response rate of the liquid crystals.

When the compensation module 2 receives the electric signal of the receiving module 1, the corresponding transmission paths can also be determined according to the line selection signals. Accordingly, the signal distortion compensation weights for the transmission paths and the over-driving signal compensation weight for accelerating the response rate of the liquid crystals corresponding to the R, G, and B electric signals can be determined. Then the multiplexer 21 is employed to modulate and compensate according to the common signal distortion compensation codes of the R, G, and B electric signals for the transmission paths and the common over-driving signal compensation codes of the R, G, and B electric signals for accelerating the response rate of the liquid crystals in the mapping table. Finally, the output module 3 is utilized to output the compensated electric signals to the display panel for displaying. However, the signal distortion compensation codes for the transmission paths and the over-driving signal compensation codes for accelerating the response rate of the liquid crystals corresponding to the R, G, and B electric signals of the corresponding transmission paths are not directly determined through the mapping table, and they are determined through the common signal distortion compensation codes for the transmission paths and the corresponding signal distortion compensation weights for the transmission paths, as well as the common over-driving signal compensation codes for accelerating the response rate of the liquid crystals and the corresponding over-driving signal compensation weight for accelerating the response rate of the liquid crystals in the predetermined mapping table. Furthermore, the signal distortion compensation code corresponding to the transmission path=the common signal distortion compensation codes for the transmission path * the corresponding signal distortion compensation weight for the transmission path (such as signal compensation code 1=the common signal distortion compensation codes * the signal distortion compensation weights).

The over-driving signal compensation code for accelerating the response rate of the liquid crystals corresponding to the transmission path=common over-driving signal compensation codes * the corresponding over-driving signal compensation weight (such as over-driving compensation code 1=common over-driving signal compensation codes * over-driving signal compensation weight 1).

The driving circuit compensates the electric signals of the various transmission paths by setting the common signal distortion compensation codes of the transmission path and the signal distortion compensation weights corresponding to the transmission paths, and by setting the common over-driving signal compensation codes of the transmission paths and the over-driving signal compensation weight corresponding to the transmission paths.

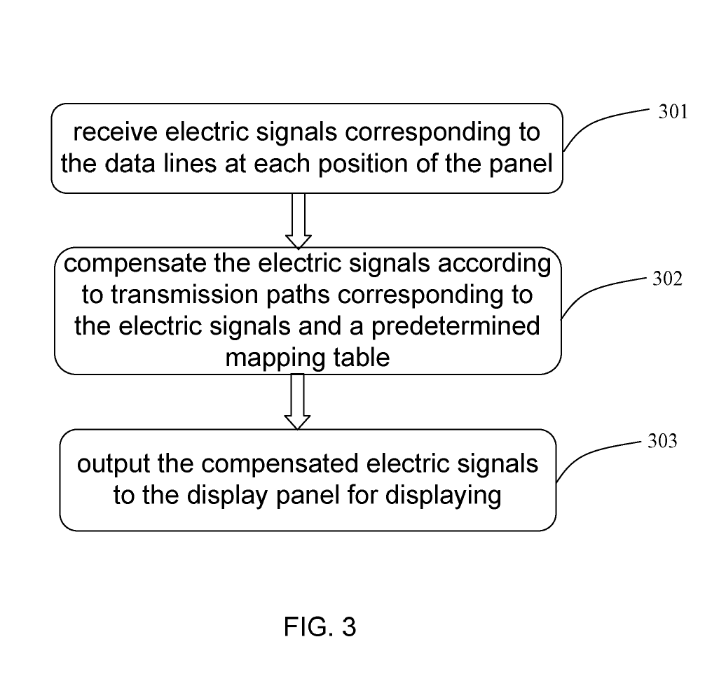

The present invention further relates a driving method of an LCD. In FIG. 3 that is a flow chart illustrating a driving method of the LCD according to a preferred embodiment of the present invention, the LCD includes a panel and a plurality of data lines 4. The driving method of the LCD begins with step 301.

At step 301, the electric signals corresponding to the data lines at each position of the panel are received.

At step 302, the electric signals are compensated according to the transmission paths corresponding to the electric signals and the predetermined mapping table.

At step 303, the compensated electric signals are outputted to the display panel for displaying.

The driving method of the LCD ends with step 301.

Before entering the output module 3, the electric signals in the driving method on the LCD of the present invention enter the compensation module 2 for performing compensation for the electric signals. Accordingly, the voltages of the electric signals outputted to the data line 4 of various positions on the panel can be modified, and then the depth d of the fan-out region can be reduced for achieving an objective of a narrow bezel. Meanwhile, it can perform an amendment for the non-uniformity of the luminance on the display panel through the compensation of the signals.

In accordance with the driving method of the LCD the preferred embodiment of the present invention, the predetermined mapping table in the compensation module 2 is mapping relations between the transmission paths and signal distortion compensations as well as over-driving signal compensations corresponding to the electric signals. The signal distortion compensations herein are signal distortion compensations for the transmission paths of R electric signals, B electric signals, or G electric signals. The over-driving signal compensations herein are over-driving signal compensations for accelerating response rate of liquid crystals of the R electric signals, the B electric signals, or the G electric signals.

The compensation capability for the electric signal is added to the compensation module 2 in the driving method of the LCD of the present invention. The compensation module 2 employs line selection signals to perform multitasking select aimed at the signal distortion compensations for the transmission paths and the over-driving signal compensating outputs for accelerating the response rate of the liquid crystals corresponding to the R, G, and B electric signals. The predetermined mapping table is utilize to perform different compensations for the signal distortions for the transmission paths and the over-driving signal outputs for accelerating the response rate of the liquid crystals corresponding to the R, G, and B electric signals of the transmission paths, thereby achieving the objective of increasing the uniformity on the display panel.

In accordance with the driving method of the LCD the preferred embodiment of the present invention, the signal distortion compensation codes for the transmission paths and the over-driving signal compensation codes for accelerating the response rate of the liquid crystals corresponding to the R, G, and B electric signals of the various transmission paths are disposed in the predetermined mapping table; or the common signal distortion compensation codes of the transmission path corresponding to the R, G, and B electric signals, and the common over-driving signal compensation codes for accelerating the response rate of the liquid crystals corresponding to the R, G, and B electric signals, and the signal distortion compensation weights for the transmission paths corresponding to the various transmission paths, and the over-driving signal compensation weights for accelerating the response rate of the liquid crystals corresponding to the various transmission paths are disposed in the predetermined mapping table. The signal distortion compensation codes corresponding to the R, G, and B electric signals of the various transmission paths are the produces of the common signal distortion compensation codes for the transmission paths corresponding to the R, G, and B electric signals times the corresponding signal distortion compensation weights for the transmission paths. The over-driving signal compensation codes for accelerating the response rate of the liquid crystals corresponding to the R, G, and B electric signals of the various transmission paths are the produces of the common over-driving signal compensation codes for accelerating the response rate of the liquid crystals corresponding the R, G, and B electric signals times the corresponding over-driving signal compensation weight for accelerating the response rate of the liquid crystals.

Specific implementing method and advantageous effects of the driving method of the present invention are the same or similar to the above-mentioned embodiment of the driving circuit of the LCD, and detail describes can refer to the above-mentioned embodiment of the driving circuit of the LCD.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A driving circuit of a liquid crystal display (LCD), the LCD comprising a panel and a plurality of data lines, characterized in that the driving circuit of the LCD comprises:
a receiving module for receiving electric signals corresponding to the data lines at each position of the panel;
a compensation module for compensating the electric signals according to transmission paths corresponding to the electric signals and a predetermined mapping table; and
an output module for outputting the compensated electric signals to the display panel for displaying;
the predetermined mapping table in the compensation module being mapping relations between the transmission paths and signal distortion compensations as well as over-driving signal compensations corresponding to the electric signals;
the compensation module comprising a multiplexer to perform modulation compensation for multiplexed signals, said multiplexer coupled to the receiving module and the output module.

2. The driving circuit according to claim 1, characterized in that signal distortion compensation codes and over-driving signal compensation codes corresponding to the electric signals of the various transmission paths are disposed in the predetermined mapping table.

3. The driving circuit according to claim 1, characterized in that common signal distortion compensation codes, common over-driving signal compensation codes, signal distortion compensation weights corresponding to the electric signals of the various transmission paths, and over-driving signal compensation weights corresponding to the electric signals of the various transmission paths are disposed in the predetermined mapping table.

4. The driving circuit according to claim 3, characterized in that signal distortion compensation codes corresponding to the electric signals of the various transmission paths are produces of the common signal distortion compensation codes times the corresponding signal distortion compensation weights, and over-driving signal compensation codes corresponding to the electric signals of the various transmission paths are produces of the common over-driving signal compensation codes times the corresponding over-driving signal compensation weights.

5. A driving circuit of an LCD, the LCD comprising a panel and a plurality of data lines, characterized in that the driving circuit of the LCD comprises:
a receiving module for receiving electric signals corresponding to the data lines at each position of the panel;
a compensation module for compensating the electric signals according to transmission paths corresponding to the electric signals and a predetermined mapping table; and
an output module for outputting the compensated electric signals to the display panel for displaying.

6. The driving circuit according to claim 5, characterized in that the predetermined mapping table in the compensation module is mapping relations between the transmission paths and signal distortion compensations as well as over-driving signal compensations corresponding to the electric signals.

7. The driving circuit according to claim 6, characterized in that signal distortion compensation codes and over-driving signal compensation codes corresponding to the electric signals of the various transmission paths are disposed in the predetermined mapping table.

8. The driving circuit according to claim 6, characterized in that common signal distortion compensation codes, common over-driving signal compensation codes, signal distortion compensation weights corresponding to the electric signals of the various transmission paths, and over-driving signal compensation weights corresponding to the electric signals of the various transmission paths are disposed in the predetermined mapping table.

9. The driving circuit according to claim 8, characterized in that signal distortion compensation codes corresponding to the electric signals of the various transmission paths are produces of the common signal distortion compensation codes times the corresponding signal distortion compensation weights, and over-driving signal compensation codes corresponding to the electric signals of the various transmission paths are produces of the common over-driving signal compensation codes times the corresponding over-driving signal compensation weights.

10. The driving circuit according to claim 6, characterized in that the signal distortion compensations are signal distortion compensations for the transmission paths of R electric signals, B electric signals, or G electric signals.

11. The driving circuit according to claim 6, characterized in that the over-driving signal compensations are over-driving signal compensations for accelerating response rate of liquid crystals of R electric signals, B electric signals, or G electric signals.

12. The driving circuit according to claim 5, characterized in that the compensation module comprises a multiplexer to perform modulation compensation for multiplexed signals, and said multiplexer is coupled to the receiving module and the output module.

13. A method for driving an LCD, the LCD comprising a panel and a plurality of data lines, characterized in that the method comprises the step of:
A, receiving electric signals corresponding to the data lines at each position of the panel;
B, compensating the electric signals according to transmission paths corresponding to the electric signals and a predetermined mapping table; and
C, outputting the compensated electric signals to the display panel for displaying.

14. The method according to claim 13, characterized in that the predetermined mapping table in step B is mapping relations between the transmission paths and signal distortion compensations as well as over-driving signal compensations corresponding to the electric signals.

15. The method according to claim 14, characterized in that signal distortion compensation codes and over-driving signal compensation codes corresponding to the electric signals of the various transmission paths are disposed in the predetermined mapping table.

16. The method according to claim 14, characterized in that common signal distortion compensation codes, common over-driving signal compensation codes, signal distortion compensation weights corresponding to the electric signals of the various transmission paths, and over-driving signal compensation weights corresponding to the electric signals of the various transmission paths are disposed in the predetermined mapping table.

17. The method according to claim 16, characterized in that signal distortion compensation codes corresponding to the electric signals of the various transmission paths are produces of the common signal distortion compensation codes times the corresponding signal distortion compensation weights, and over-driving signal compensation codes corresponding to the electric signals of the various transmission paths are produces of the common over-driving signal compensation codes times the corresponding over-driving signal compensation weights.
